(19) United States
(12) Patent Application Publication
(10) Pub. No.: US 2022/0391683 A1
(43) Pub. Date: Dec. 8, 2022

(54) BIAS REDUCTION DURING ARTIFICAL INTELLIGENCE MODULE TRAINING

(71) Applicant: INTERNATIONAL BUSINESS MACHINES CORPORATION, ARMONK, NY (US)

(72) Inventors: Lukasz G. Cmielowski, Kraków (PL); Szymon Kucharczyk, Kraków (PL); MARTIN HIRZEL, Ossining, NY (US); Dorota Laczak, Mielec (PL)

(21) Appl. No.: 17/303,732

(22) Filed: Jun. 7, 2021

(51) Int. Cl. G06N 3/08; G06N 3/04

(52) U.S. Cl. CPC G06N 3/08; G06N 3/04

(57) ABSTRACT

Disclosed herein is a method of training an artificial intelligence model with adjustable parameters that is trained to provide an analysis result in response to receiving an input data set comprising one or more chosen variables. The method comprises: receiving a training data set comprising multiple groups of training input data paired with a training analysis result, receiving a trial analysis result from the artificial intelligence model in response to inputting the multiple groups of training input data into the artificial intelligence model, calculating an accuracy metric descriptive of a comparison between the trial analysis result and the training analysis result, calculating a fairness score metric by comparing the one or more chosen variables to the trial analysis result, calculating a combined metric from the fairness score metric and the accuracy metric, and modifying the adjustable parameters using a training algorithm that receives at least the combined metric.

### BACKGROUND

The present invention relates to the training of Artificial Intelligence models.

The automated training of Artificial Intelligence (AI) modules and algorithms is extremely popular and enables a reduction in the human labor needed to train them. Successful training however, currently relies performing the training very carefully so that the artificial intelligence module does not produce results which contain systematic bias or prejudices. Currently, if the training data contains a systematic bias, then so will the trained artificial intelligence module.

### SUMMARY

In one aspect the invention provides for a method of training an artificial intelligence model. The artificial intelligence model has adjustable parameters. The adjustable parameters affect the performance and operation of the artificial intelligence model. The artificial intelligence model may therefore be trained by modifying or adjusting the adjustable parameters. The artificial intelligence model is trained to provide an analysis result in response to receiving an input data set. The input data set comprises one or more chosen variables.

The method comprises receiving a training data set for training the artificial intelligence model. The training data set comprises multiple groups of training input data paired with a training analysis result. The training input data may be data which is used as a trial basis as input into the artificial intelligence model. The output of the artificial intelligence model may then be compared with the training analysis result. The method further comprises receiving a trial analysis result from the artificial intelligence model in response to inputting the multiple groups of training input data as input data into the artificial intelligence model. In this step the training input data is input into the artificial intelligence model and in response a trial analysis result is received. The method further comprises calculating an accuracy metric descriptive of a comparison between said trial analysis result and said training analysis result. The trial analysis result, which is the result that comes out of the artificial intelligence model, is compared to the training analysis result and the accuracy metric provides a measure or value which evaluates how close or accurate the trial analysis result is to the training analysis result.

The method further comprises calculating a fairness score metric by comparing the one or more chosen variables to the trial analysis result. A fairness measure or fairness score in artificial intelligence refers to a measure how much a particular variable or in this case the one or more chosen variables affect the output of the artificial intelligence model.

The method further comprises calculating a combined metric from the fairness score metric and the accuracy metric. The method further comprises modifying the adjustable parameters of the artificial intelligence model using a training algorithm that receives at least said combined metric as input.

According to a further aspect of the present invention, the invention provides for a computer system that comprises a processor and a memory storing machine-executable instructions. The execution of the machine-executable instructions causes the processor to implement a method according to an embodiment.

According to a further aspect of the present invention, invention provides for a computer program product comprising a computer-readable storage medium having a computer-readable program code embodied therewith. The computer-readable program code is configured to implement a method according to an embodiment.

According to a further aspect of the present invention, the invention provides for a computer program product. The computer program product comprises a computer-readable storage medium having stored on it an artificial intelligence model trained according to an embodiment of the method.

According to a further aspect of the present invention, the invention provides for a memory storing data for access by an application program being executed on a data processing system. This comprises an artificial intelligence model trained according to an embodiment of the method.

### BRIEF DESCRIPTION OF THE SEVERAL VIEWS OF THE DRAWINGS

In the following embodiments of the invention are explained in greater detail, by way of example only, making reference to the drawings in which:

FIG. 1 illustrates an example of a computer system;

FIG. 2 shows an exemplary computing environment where the computer system of FIG. 1 is connected;

FIG. 3 illustrates a further example of a computer system;

FIG. 4 shows a flow chart which illustrates a method of using the computer system of FIG. 3;

FIG. 5 illustrates a further example of a computer system; and

FIG. 6 shows a flow chart which illustrates a method of using the computer system of FIG. 5.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Embodiments may be beneficial because they may provide for a means of reducing unwanted bias on the one or more chosen variable. This for example may enable the training of an artificial intelligence module with reduced bias although the training data set contains unwanted biases or prejudices.

For example, an artificial intelligence model trained to evaluate if and when maintenance of a machine should be performed. There may be bias due to previous experience and personal preference in the data used to train the artificial intelligence model.

Normally when artificial intelligence models are trained only the accuracy metric is used to evaluate and then modify the adjustable parameters. The combined metric may provide a means of balancing the needs of an artificial intelligence model to provide accurate results with providing so called fair results. That is to try to eliminate unwanted bias in particular variables or in this case, the one or more chosen variables.

Instead of using, for example, just as accuracy metric as the input for the training algorithm, the combined metric is used instead. As was just described above, this may provide for a means of removing unwanted bias in the one or more chosen variables. In the example of a neural network the accuracy metric could be a loss function. In the case of a neural network the combined metric may be used as an input to a back propagation algorithm instead of the result of the accuracy metric. For a neural network the combined metric would be a modified loss function that combines the value of the fairness score metric with the normal or conventional loss function.

In another embodiment the method further comprises providing a fairness weighted ranking for each of the multiple trained artificial intelligence models by first receiving the multiple trained artificial intelligence models. The multiple trained artificial intelligence models comprise an artificial intelligence model. The fairness weighted ranking for each of the multiple trained artificial intelligence models may for example be a ranking which identifies how much each of the multiple trained artificial intelligence models has a bias in the one or more chosen variables.

The method further comprises receiving a testing data set for testing said multiple intelligence models. The testing data set comprises multiple groups of testing input data paired with a testing analysis result. The testing data set is essentially trial data that is used to input into each of the multiple trained artificial intelligence models. For a particular testing data set there is a testing analysis result which is essentially a ground truth or data which has been labeled to provide the correct or desired output of one of the artificial intelligence models.

The method further comprises receiving a mitigation analysis result from each of said multiple artificial intelligence models in response to inputting said multiple groups of testing input data as said input data set. The mitigation analysis result may be considered to be the result of a trial of the multiple artificial intelligence models.

The method further comprises calculating an accuracy score for each of the multiple trained artificial intelligence models descriptive of a comparison between the mitigation analysis result for each of the multiple trained artificial intelligence models and the testing analysis result.

The method further comprises calculating a fairness rating metric for each of the multiple trained artificial intelligence models by comparing the one or more chosen variables to the trial analysis result. The accuracy score is the measure of how accurate each of the multiple trained artificial intelligence models are. The fairness rating metric provides a measure of how much unwanted bias there is in the one or more chosen variables for each of the multiple trained artificial intelligence models.

The method then comprises calculating the fairness weighted ranking for each of the multiple trained artificial intelligence models by combining the fairness rating metric and the accuracy score for each of the multiple trained artificial intelligence models. So instead of ranking the multiple trained artificial intelligence models by using the accuracy score the combined accuracy score and fairness rating metric is used instead. This provides not just a value of how accurate the model is but how much unwanted bias there is in the various artificial intelligence models. The fairness weighted ranking may then be useful for either automated selection of the best artificial intelligence model or may be displayed to a user and a user may decide to select which model is used based on the fairness weighted ranking.

In another embodiment the fairness rating metric is descriptive of a correlation between one or more chosen values of said one or more chosen variables and the trial analysis result. For example, the fairness rating metric can be calculated to see if particular values of the one or more chosen variables are discriminated against. Using the example mentioned before a particular gender could be chosen and it could be seen if this particular gender results in a bias in the trained artificial intelligence models. This may be beneficial because the fairness rating metric can be used to check for particular biases in the trained artificial intelligence models.

In another embodiment the multiple trained artificial intelligence models are different types. For example, the multiple trained artificial intelligence models could use different neural network topologies. In other examples the different types could be even completely different implementations of artificial intelligence. One example would be where some models are neural networks and other models are Bayesian decision models. This embodiment may be beneficial because it may enable the best artificial intelligence topology and/or model type to be selected.

In another embodiment one of the multiple trained artificial intelligence models is a neural network.

In another embodiment one of the multiple trained artificial intelligence models is a classifier neural network.

In another embodiment one of the multiple trained artificial intelligence models is a convolutional neural network.

In another embodiment one of the multiple trained artificial intelligence models is a Bayesian neural network.

In another embodiment one of the multiple trained artificial intelligence models is a Bayesian network.

In another embodiment one of the multiple trained artificial intelligence models is a Bayes network.

In another embodiment one of the multiple trained artificial intelligence models is a naive Bayes classifier.

In another embodiment one of the multiple trained artificial intelligence models is a belief network.

In another embodiment one of the multiple trained artificial intelligence models is a decision network.

In another embodiment one of the multiple trained artificial intelligence models is a decision tree.

In another embodiment one of the multiple trained artificial intelligence models is a support-vector machine.

In another embodiment one of the multiple trained artificial intelligence models is a regression analysis.

In another embodiment one of the multiple trained artificial intelligence models is a genetic algorithm.

In another embodiment the fairness weighted ranking comprises a least squared combination of the fairness rating metric and the accuracy score.

In another embodiment the fairness weighted ranking comprises a weighted least squares combination of the fairness rating metric and the accuracy score. For example, the fairness rating metric could be squared and then multiplied by a first coefficient and then the accuracy score is squared and multiplied by a second coefficient and then the two are added.

In another embodiment the fairness weighted ranking comprises a linear combination of the rating metric and the accuracy score.

In another embodiment the fairness weighted ranking comprises a weighted combination of the fairness rating metric and the accuracy score.

In another embodiment the fairness weighted ranking comprises a polynomial combination of the fairness rating metric and the accuracy score. For example, a polynomial equation could be chosen with various coefficients and then the fairness rating metric and the accuracy score could each be put into the polynomial in different combinations.

In another embodiment the combined metric is an accuracy score multiplied by a scaling factor that is then raised to a predetermined power. The scaling factor is a function of the fairness rating metric. This embodiment may be beneficial because this has been shown to provide a good combined measure of the fairness and accuracy.

In another embodiment the scaling factor is a reciprocal of the fairness rating metric.

In another embodiment the fairness score metric is descriptive of a correlation between one or more chosen values of said one or more chosen variables and the trial analysis result. The fairness score metric is used for evaluating the artificial intelligence model during training. In this embodiment particular values of the one or more chosen values can be selected and these can be evaluated if they are discriminated against or have unwanted biases. For example, one could train the model such that a discrimination against a particular gender is avoided.

In another embodiment the combined metric comprises a least squares combination of the fairness score metric and the test metric. The combined metric comprises a weighted least squares combination of the fairness score metric and the test metric.

In another embodiment the combined metric comprises a linear combination of the fairness score metric and the test metric.

In another embodiment the combined metric comprises a weighted combination of the fairness score metric and the test metric.

In another embodiment the combined metric comprises a polynomial combination of the fairness score metric and the test metric.

In another embodiment the combined metric comprises a constraint on the fairness score metric. For example, the constraint could be limited on how large the fairness score metric is allowed to become. This may provide for a trained artificial intelligence model that has a limit on how much bias there is against a particular variable.

In another embodiment the combined metric comprises a constraint on the test metric. This may for example be useful because it may be used to limit the training such that there is a minimum accuracy that is acceptable for the training. This may help to construct models that are not only fair but are also accurate.

In another embodiment the combined metric comprises a maximum allowed value for the fairness score metric.

In another embodiment the combined metric comprises a maximum allowed value for the test metric.

In another embodiment the artificial intelligence model is a neural network.

In another embodiment the artificial intelligence model is a classifier neural network.

In another embodiment the artificial intelligence model is a convolutional neural network.

In another embodiment the artificial intelligence model is a Bayesian neural network.

In another embodiment the artificial intelligence model is a Bayesian network.

In another embodiment the artificial intelligence model is a Bayes network.

In another embodiment the artificial intelligence model is a naïve Bayes classifier.

In another embodiment the artificial intelligence model is a belief network.

In another embodiment the artificial intelligence model is a decision network.

In another embodiment the artificial intelligence model is a decision tree.

In another embodiment the artificial intelligence model is a support-vector machine.

In another embodiment the artificial intelligence model is a regression analysis.

In another embodiment the artificial intelligence model is a genetic algorithm.

In another embodiment the artificial intelligence model is a convolutional neural network. The training algorithm is a deep learning algorithm. For example, the training algorithm may be a back propagation algorithm that uses the combined metric as the loss function.

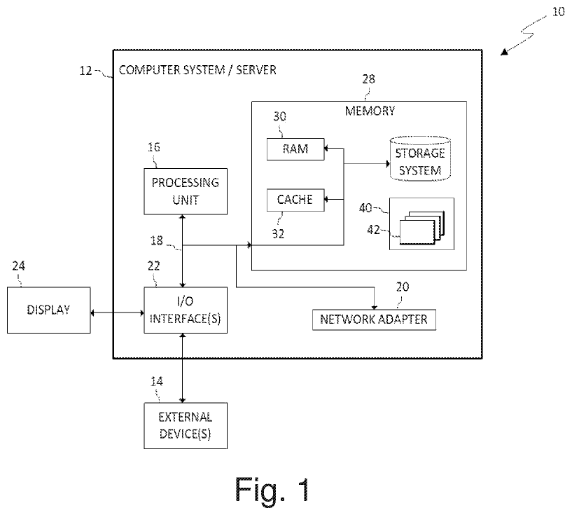

Embodiments of the present invention may be implemented using a computing device that may also be referred to as a computer system, a client, or a server. Referring now to FIG. 1, a schematic of an example of a computer system is shown. Computer system 10 is only one example of a suitable computer system and is not intended to suggest any limitation as to the scope of use or functionality of embodiments of the invention described herein. Regardless, computer system 10 is capable of being implemented and/or performing any of the functionality set forth hereinabove.

In computer system 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 12 in computer system 10 is shown in the form of a general-purpose computing device. The components of computer system/server 12 may include, but are not limited to, one or more processors or processing units 16, a system memory 28, and a bus 18 that couples various system components including system memory 28 to processor 16. Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

A computer system such as the computer system 10 shown in FIG. 1 may be used for performing operations disclosed herein such as training an artificial intelligence module. Such computer system may be a standalone computer with no network connectivity that may receive data to be processed, such as a training data set for training an artificial intelligence module, through a local interface. Such operation may, however, likewise be performed using a computer system that is connected to a network such as a communications network and/or a computing network.

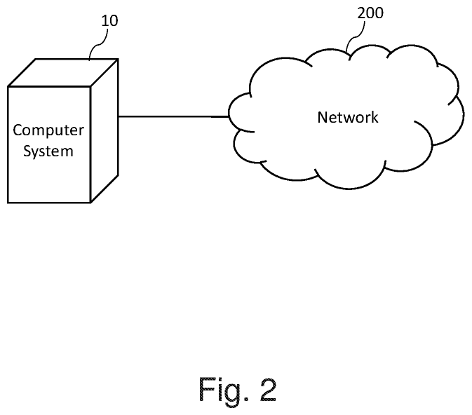

FIG. 2 shows an exemplary computing environment where a computer system such as computer system 10 is connected, e.g., using the network adapter 20, to a network 200. Without limitation, the network 200 may be a communications network such as the internet, a local-area network (LAN), a wireless network such as a mobile communications network, and the like. The network 200 may comprise a computing network such as a cloud-computing network. The computer system 10 may receive data to be processed, such as a training data set for training an artificial intelligence model, from the network 200 and/or may provide a computing result, such as a trained artificial intelligence module after it has been trained using the training data set, to another computing device connected to the computer system 10 via the network 200.

The computer system 10 may perform operations described herein, entirely or in part, in response to a request received via the network 200. In particular, the computer system 10 may perform such operations in a distributed computation together with one or more further computer systems that may be connected to the computer system 10 via the network 200. For that purpose, the computing system 10 and/or any further involved computer systems may access further computing resources, such as a dedicated or shared memory, using the network 200.

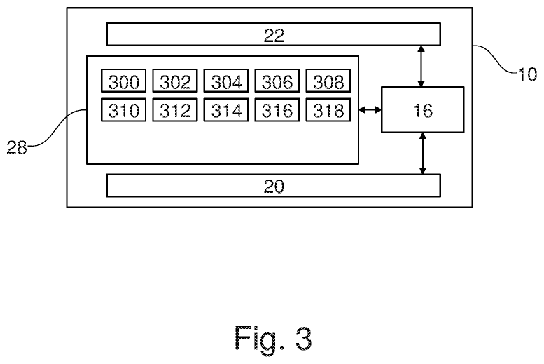

FIG. 3 illustrates an idealization of the computer system 10. The processing unit 16 or processor of the computer 10 as well as the network adaptor 20 and the I/O interface 22 are depicted. The memory 28 represents the various types of memory that the processing unit 16 can access. The processing unit is shown as containing machine-executable instructions 300. The machine-executable instructions 300 are equivalent to one of the program modules 42. The various contents of the memory 28 may be stored in various locations such as the RAM 30, the cache 32 or in a persistent memory. The memory 28 is further shown as containing an artificial intelligence model 302 that has adjustable parameters.

The artificial intelligence model may be trained to provide an analysis result in response to receiving an input data set. The memory 28 is further shown as containing a training data set 304 which is used for training the artificial intelligence model 302. The training data set 304 can be broken into groups of multiple groups of training input data 306 and a training analysis result 308 that may be available for each of the training input data. The training input data 306 may be input into the artificial intelligence model 302 and provide a trial analysis result 310. This is shown as being stored in the memory 28.

The memory 28 is further shown as containing an accuracy metric 312. The accuracy metric 312 was calculated between the trial analysis result 310 and the training analysis result 308. The memory 28 is further shown as containing a fairness score metric 314 calculated by comparing one or more chosen variables of the input data set to the trial analysis result 310. The memory 28 is further shown as containing a combined metric 316 that was calculated by combining the fairness score metric 314 and the accuracy metric 312. The combined metric 316 is then used in conjunction with the training algorithm 318 to adjust the adjustable parameters of the artificial intelligence model 302.

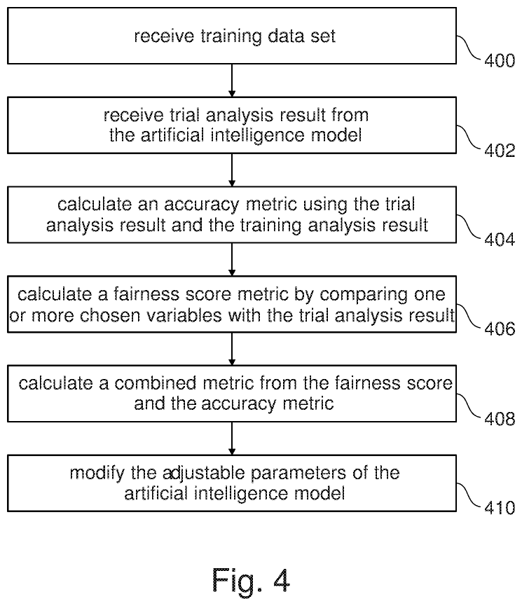

FIG. 4 shows a flowchart which illustrates a method of operating the computer 10 of FIG. 3. First, in step 400, the training data set 304 is received. Next, in step 402, the trial analysis result 310 is received from the artificial intelligence model 302 in response to inputting the multiple groups of input training data 306 as the input data set into the artificial intelligence model 302. Next, in step 404, the accuracy metric 312 is calculated and it is descriptive of a comparison between the trial analysis result 310 and the training analysis result 308. Then, in step 406, the fairness score metric 314 is calculated by comparing the one or more chosen variables to the trial analysis result 310. Next, in step 408, the combined metric 316 is calculated from the fairness score metric 314 and the accuracy metric 312. Finally, in step 410, the adjustable parameters of the artificial intelligence model 302 are modified using a training algorithm 318 that receives at least the combined metric 316 as input.

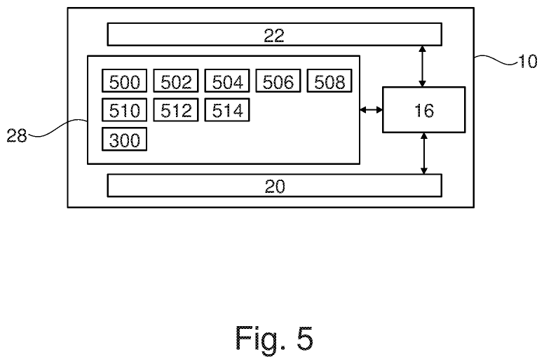

FIG. 5 shows a further view of the computer 10. The features of the computer 10 depicted in FIG. 3 may be combined with the features depicted in FIG. 5.

The memory 28 is shown as containing the machine-executable instructions 300. The memory is further shown as containing multiple training artificial intelligence models 500. The artificial intelligence model 302 depicted in FIG. 3 may possibly be one of the multiple trained artificial intelligence models 500. The memory 28 is further shown as containing a testing data set 502 that comprises testing input data 504 and testing analysis result 506. The testing data set 502 is used to test and evaluate the multiple trained artificial intelligence models 500. The testing input data 504 is used as the input and the output of the various artificial intelligence models is compared to the testing analysis result.

The memory 28 is further shown as containing a mitigation analysis result. The mitigation analysis result 508 is the result returned by the various artificial intelligence models when the testing input data is input into them. The memory 28 is further shown as containing an accuracy score 510. The accuracy score 510 is a score which rates how accurate the mitigation analysis result 508 is to the testing analysis result 506. The memory 28 is further shown as containing a fairness rating metric 512 that was calculated for each of the multiple trained artificial intelligence models 500 by comparing the one or more chosen variables to the mitigation analysis result 508. The memory 28 is further shown as containing a fairness weighted ranking 514. The fairness weighted ranking 514 is a combination of the accuracy score 510 and the fairness rating metric 512.

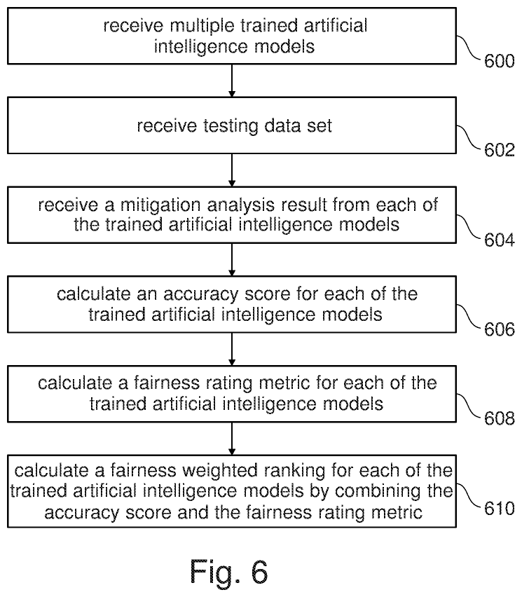

FIG. 6 shows a flowchart which illustrates a method of operating the computer system 10 of FIG. 5. The flowchart illustrated in FIG. 6 may be combined with the flowchart illustrated in FIG. 4. For example, after the training of the various artificial models has been performed using the method illustrated in FIG. 4, the multiple trained artificial intelligence models may be compared using the method illustrated in FIG. 6.

First, in step 600, the multiple trained artificial intelligence models 500 are received. Next, in step 502, the testing data set 502 is received. Next, in step 604, the mitigation analysis result 508 is received by inputting the testing input data 504 into the various trained artificial intelligence models 500. Next, in step 606, the accuracy score 510 is calculated for each of the multiple trained artificial intelligence models 500 by comparing the mitigation analysis result 508 for the particular intelligence models 500 and the testing analysis result 506. Next, in step 608, the fairness rating metric 512 is calculated for each of the multiple trained artificial intelligence models 500 by comparing the one or more chosen variables to the mitigation analysis result 508. Finally, in step 610, the fairness weighted ranking 514 is calculated for each of the multiple trained artificial intelligence models 500 by combining the fairness rating metric 512 and the accuracy score 510.

The automatic machine learning approach is very popular nowadays. It allows to automate manual data scientist work and speed up the model development process. Unfortunately finding the best model may require a significant amount of time and resources. The goal of automatic machine learning processes is to find the most accurate model.

Making sure that model is fair is another aspect that may be relevant nowadays. There are dedicated monitoring systems or libraries that are configured for assessing model fairness and allowing for mitigation.

Embodiments may inject bias checking and mitigation procedures to automatic machine learning processes. The procedures are based on a scorers concept.

Example systems may possibly be based on two modules a detection model (used for calculating the combined metric to modify the adjustable parameters of the artificial intelligence module) and a mitigation module (to provide the fairness rating metric for the multiple trained artificial intelligence modules). Modules can be used separately or together.

1. Detection Module

The detection module may be based on extending a regular scorers list by a fairness calculation scorer (fairness rating metric). A scorer function (referred to herein as an accuracy score) is used to evaluate a machine learning model (artificial intelligence model). Sample scorers include accuracy, the Brier score loss, average precision, balanced accuracy, f1 score, and others. During each stage of automatic ML (autoML) process the selected scorer is used to optimize the search process, so that the model with the best scorer value is found. The scorer is used to optimize the search process, so that the model with the best scorer value is found. The scorers are machine learning scorers describing performance (accuracy) of the model. These are referred to as “ml_scorers” herein.

In this module there is an extended list of scorers by adding fairness metric scorers (fairness score metric) to the process. In other words, new types scorers have been injected to existing ML architectures. This is referred to as a “fairness_scorer” or fairness score metric herein. Each time the ml_scorer is calculated the “fairness_scorer” (since added to the scorers list) may be executed as well.

As a result, new metrics may be returned to the user, next to machine learning metrics such as: accuracy, precision, and recall, the fairness score metric is calculated. The fairness score metric is referred to herein as the disparate_impact and is calculated under “fairness_metrics” category.

To calculate disparate_impact some information about possible adversities or biases in the dataset may be provided. This information about possible biases or prejudices is referred to as “fairness_info” herein. Fairness_info examples and explanation and is described below. This information is passed to autoML system as a parameter and the fairness score metric is calculated for each stage of the detection module based on that information. An exemplary call of the system in pseudocode with fairness info is presented below:

```
>>> automl= AutoMLSystem(scorer= ‘accuracy’,
    learning_type= ‘classification’,
    positive_label= “No Risk”,
    fairness_info= fairness_info
  )
>>> automl.fit(training_data, training_labels)
```

‘accuracy’ refers to the type of accuracy metric used. The “training_data” corresponds to the training input data and the “training_labels” corresponds to the training analysis result. The protected attributes of the fairness info below correspond to the one or more chosen variables. The “privileged_groups” of the “protected_attributes” corresponds to the one or more chosen values of the one or more chosen variables.

### Examples of Fairness Info:

Classification: Below examples of classifications of “privileged_groups” that may be particular values of the one or more chosen variables which may be biased.

```
fairness_info= {
  “protected_attributes”: [
    {“feature”: “Gender”, “privileged_groups”: [‘male’]},
    {“feature”: “Age”, “privileged_groups”: [[0.0, 40.0]]},
  ],
“favorable_labels”: [“No Risk”]}
  - Regression
fairness_info= {
      “favorable_labels”: [[−100000.0, 100]],
      “protected_attributes”:[
        {“feature”: “B”, “privileged_groups”: [[0.0, 40.0]]},
    ]}
```

### Where

protected_attribute (dictionary of items)—subset of feature names and privileged groups for which fairness is desired.
favorable_labels (array)—label values which are considered favorable (i.e. “positive”). Available types: string, number, array of number

### Exemplary Metrics Output:

Score for pipeline 0: disparate impact: 0.81, accuracy and disparate impact: 0.71

Score for pipeline 1: disparate impact: 0.84, accuracy and disparate impact: 0.77

Score for pipeline 2: disparate impact: 0.67, accuracy and disparate impact: 0.82

Score for pipeline 3: disparate impact: 0.66, accuracy and disparate impact: 0.84

Above, the “disparate impact” is the “fairness score metric” and “the accuracy and disparate impact” is the “combined metric.”

2. Mitigation Module

The mitigation module is again based on a scorer approach. Here the so-called combined scorer is introduced once more. The combined scorer that combines both ML (accuracy score) and a fairness metric (fairness rating metric) based on some weights and is also referred to herein as the fairness weighted ranking or ‘accuracy_and_disparate_impact_scorer’ herein. Next, such scorer is set as a ranking scorer and used for optimization process. Which is the process that is responsible for finding the best model according to a calculated score value (the fairness weighted ranking). In the mitigation module it is a combined value. It is calculated for each stage of the autoML system, but in addition it is used for model ranking during the model selection step (by providing a fairness weighted ranking for each of the multiple trained artificial intelligence models). One of the combined scorers is a fairness scorer (fairness rating metric) and is analogous to the fairness score metric of the detection module, it may be calculated with all autoML system steps and uses provided fairness_info also. Final value of the combined scorer depends on the disparate impact ratio:

When the fairness metric (fairness rating metric) is NaN (not a number such as is caused by division by zero), because the fairness info is not suitable for the dataset sample (e.g. sample from k-fold cross-validation) the second metric from combined metrics is returned, for instance accuracy.

When disparate impact ratio (fairness rating metric) is equal to 0.0, the final value of the combined metric (fairness weighted ranking) is 0.0

Otherwise, the combined metric is calculated as a mixture of both metrics using the following equation:

Accuracy (accuracy score) and disparage impact (fairness rating metric)=accuracy*(scaling factor)\hat{ }(scaling hardness)

Where:

Scaling factor depends on disparate impact threshold, that is a parameter set to 0.9 (values above this threshold are considered fair) and symmetric impact value, that is a parameter described below. When the disparate impact is between 0 and 0.9, the symmetric impact is equal to disparate impact. When the disparate impact is greater than 1.0, the symmetric impact is calculated using the following equation:

scaling_factor=(symmetric impact)/(disparate impact threshold)

scaling hardness is a parameter set to 4.0.

There are two combined scorers (for calculating the fairness weighted ranking) available in an exemplary mitigation module:
regression: r2_and_disparage_impact
classification: accuracy_and_disparate_impact

### Exemplary Call of Mitigation Module:

```
>>> automl = AutoMLSystem(scorer =
‘accuracy_and_disparate_impact’,
    learning_type= ‘classification’
    positive_label= “No Risk”,
    fairness_info= fairness_info
  )
>>> automl.fit(training_data, training_labels)
```

### Examples of Fairness Info:

```
-Classification
Fairness_info ={
  “protected_attributes”:[
    {“feature”: “GENDER”, “privileged_groups”; [‘F’]},
    {“feature”: “BP”, “privileged_groups”: [“LOW”, “NORMAL”]}
  ],
“favorable_labels”: [“drugA”, “durgC”]}
```

### Exemplary Metrics Output:

Score for pipeline 0: disparate impact: 0.60, accuracy and disparate impact: 0.64

Score for pipeline 1: disparate impact: 0.66, accuracy and disparate impact: 0.68

Score for pipeline 2: disparate impact: 0.71, accuracy and disparate impact: 0.77

Score for pipeline 3: disparate impact: 0.70, accuracy and disparate impact: 0.81

Above, the “disparate impact” is the “fairness rating metric” and the “accuracy and disparate impact” is the “fairness weighted ranking.”

The model ranking can be also done for ease of interpretation using both metrics (separated): machine learning metric like accuracy and fairness metric like disparate impact. That allows for a useful presentation to the end user and the ability to rank and/or sort based on the selected metric.

That selection can also be easily extended to filtering based on some thresholds. The user set constraints, for example, that provide the best fairness pipeline but with a precision not less than 0.8.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Various examples may possibly be described by one or more of the following features in the following numbered clauses:

Clause 1. A method of training an artificial intelligence model, wherein the artificial intelligence model has adjustable parameters, wherein said artificial intelligence model is trained to providing an analysis result in response to receiving an input data set, wherein said input data set comprises one or more chosen variables, said method comprising:

receiving a training data set for training said artificial intelligence model, wherein said training data set comprises multiple groups of training input data paired with a training analysis result;

receiving a trial analysis result from said artificial intelligence model in response to inputting said multiple groups of training input data as said input data set into said artificial intelligence model;

calculating an accuracy metric descriptive of a comparison between said trial analysis result and said training analysis result;

calculating a fairness score metric by comparing said one or more chosen values to said trial analysis result;

calculating a combined metric from said fairness score metric and said accuracy metric;

modifying the adjustable parameters of the artificial intelligence model using a training algorithm that receives at least said combined metric as input.

Clause 2. The method of clause 1, wherein said method further comprises providing a fairness weighted ranking for each of multiple trained artificial intelligence models by:

receiving said multiple trained artificial intelligence models, wherein said multiple trained artificial intelligence models comprise said artificial intelligence model;

receiving a testing data set for testing said multiple intelligence models, wherein said testing data set comprises multiple groups of testing input data paired with a testing analysis result;

receiving a mitigation analysis result from each of said multiple artificial intelligence models in response to inputting said multiple groups of testing input data as said input data set;

calculating an accuracy score for each of said multiple trained artificial intelligence models descriptive of a comparison between said mitigation analysis result for each of said multiple trained artificial intelligence models and said testing analysis result;

calculating a fairness rating metric for each of said multiple trained artificial intelligence models by comparing said one or more chosen values to said trial analysis result; and

calculating said fairness weighted ranking for each of said multiple trained artificial intelligence models by combing said fairness rating metric and accuracy score for each of multiple trained artificial intelligence models.

Clause 3. The method of clause 2, wherein said fairness rating metric is descriptive of a correlation between one or more chosen values of said one or more chosen variables and said trial analysis result.

Clause 4. The method of clause 2 or 3, wherein said multiple trained artificial intelligence models are of different types.

Clause 5. The method of clause 2, 3, or 4, each of said multiple trained artificial intelligence models are independently any one of the following: a neural network, a classifier neural network, a convolutional neural network, a Bayesian neural network, a Bayesian network, a Bayes network, naive Bayes classifiers, belief network, or decision network, a decision trees, a support-vector machine, a regression analysis, and a genetic algorithm.

Clause 6. The method of any one of the preceding clauses, wherein said fairness weighted ranking comprises any one of the following: a least squares combination of said fairness rating metric and said accuracy score, weighted lease squares combination of said fairness rating metric and said accuracy score, a linear combination of said fairness rating metric and said accuracy score, a weighted combination of said fairness rating metric and said accuracy score, and a polynomial combination of said fairness rating metric and said accuracy score.

Clause 7. The method of any one of clauses 2 to 5, wherein said combined metric is said accuracy score multiplied by a scaling factor raised to a predetermined power, wherein said scaling factor is a function of said fairness rating metric.

Clause 8. The method of clause 7, wherein said scaling factor is a reciprocal of said fairness rating metric.

Clause 9. The method of any one of the preceding clauses, wherein said fairness score metric is descriptive of a correlation between one or more chosen values of said one or more chosen variables and said trial analysis result.

Clause 10. The method of any one of the preceding clauses, wherein said combined metric comprises any one of the following: a least squares combination of said fairness score metric and said test metric, weighted lease squares combination of said fairness score metric and said test metric, a linear combination of said fairness score metric and said test metric, a weighted combination of said fairness score metric and said test metric, and a polynomial combination of said fairness score metric and said test metric.

Clause 11. The method of clause 9 or 10, wherein said combined metric comprises any one of the following: a constraint on said fairness score metric, a constraint on said test metric, a maximum allowed value for said fairness score metric, and a maximum allowed value for said test metric.

Clause 12. The method of any one of the preceding clauses, wherein said artificial intelligence model is any one of the following: a neural network, a classifier neural network, a convolutional neural network, a Bayesian neural network, a Bayesian network, a Bayes network, naive Bayes classifiers, belief network, or decision network, a decision trees, a support-vector machine, a regression analysis, and a genetic algorithm.

Clause 13. The method of any one of clauses 1 to 12, wherein said artificial intelligence model is a convolutional neural network, and wherein said training algorithm is a deep learning algorithm.

Clause 14. A computer program product comprising a computer-readable storage medium having computer-readable program code embodied therewith, said computer-readable program code configured to implement the method of any one of clauses 1 to 13.

Clause 15. A computer system comprising:

a processor configured for controlling the computer system; and

a memory storing machine executable instructions, wherein execution of said instructions causes said processor to:

receive a training data set for training an artificial intelligence model, wherein the artificial intelligence model has adjustable parameters, wherein said artificial intelligence model is trained to providing an analysis result in response to receiving an input data set, wherein said input data set comprises one or more chosen variables wherein said training data set comprises multiple groups of training input data paired with a training analysis result,

receive a trial analysis result from said artificial intelligence model in response to inputting said multiple groups of training input data as said input data set into said artificial intelligence model,

calculate an accuracy metric descriptive of a comparison between said trial analysis result and said training analysis result,

calculate a fairness score metric calculated by comparing said one or more chosen values to said trial analysis result,

calculate a combined metric from said fairness score metric and said accuracy metric, modifying the adjustable parameters of the artificial intelligence model using a training algorithm that receives at least said combined metric as input.

Clause 16. The computer system of clause 15, wherein execution of the instructions further causes said processor to:

receive said multiple trained artificial intelligence models, wherein said multiple trained artificial intelligence models comprises said artificial intelligence model;

receive a testing data set for testing said multiple intelligence models, wherein said testing data set comprises multiple groups of testing input data paired with a testing analysis result;

receive a mitigation analysis result from each of said multiple artificial intelligence models in response to inputting said multiple groups of testing input data as said input data set,

calculate an accuracy score for each of said multiple trained artificial intelligence models descriptive of a comparison between said mitigation analysis result for each of said multiple trained artificial intelligence models and said testing analysis result,

calculate a fairness rating metric for each of said multiple trained artificial intelligence models by comparing said one or more chosen values to said trial analysis result; and

calculate said fairness weighted ranking for each of said multiple trained artificial intelligence models by combing said fairness rating metric and accuracy score for each of multiple trained artificial intelligence models.

Clause 17. The computer system of any one of clauses 15 to 16, wherein the artificial intelligence model is any one of the following: a neural network, a classifier neural network, a convolutional neural network, a Bayesian neural network, a Bayesian network, a Bayes network, naive Bayes classifiers, belief network, or decision network, a decision trees, a support-vector machine, a regression analysis, and a genetic algorithm.

Clause 18. The computer system of any one of clauses 15 to 17, wherein said artificial intelligence model is a convolutional neural network, and wherein said training algorithm is a deep learning algorithm.

Clause 19. A computer program product, said computer program product comprising a computer readable storage medium having stored thereon an artificial intelligence model trained according to the method of any one of clauses 1 through 12.

Clause 20. A memory for storing data for access by an application program being executed on a data processing system, comprising: an artificial intelligence model trained according to the method of any one of clauses 1 through 12.

Clause 21 A method of providing a fairness weighted ranking for each of multiple trained artificial intelligence models, wherein the method comprises:

receiving said multiple trained artificial intelligence models;

receiving a testing data set for testing said multiple intelligence models, wherein said testing data set comprises multiple groups of testing input data paired with a testing analysis result;

receiving a mitigation analysis result from each of said multiple artificial intelligence models in response to inputting said multiple groups of testing input data as said input data set;

calculating an accuracy score for each of said multiple trained artificial intelligence models descriptive of a comparison between said mitigation analysis result for each of said multiple trained artificial intelligence models and said testing analysis result;

calculating a fairness rating metric for each of said multiple trained artificial intelligence models by comparing said one or more chosen values to said trial analysis result; and

calculating said fairness weighted ranking for each of said multiple trained artificial intelligence models by combing said fairness rating metric and accuracy score for each of multiple trained artificial intelligence models.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of training an artificial intelligence model, wherein the artificial intelligence model has adjustable parameters, wherein said artificial intelligence model is trained to provide an analysis result in response to receiving an input data set, wherein said input data set comprises one or more chosen variables, said method comprising:
receiving a training data set for training said artificial intelligence model, wherein said training data set comprises multiple groups of training input data paired with a training analysis result;
receiving a trial analysis result from said artificial intelligence model in response to inputting said multiple groups of training input data as said input data set into said artificial intelligence model;
calculating an accuracy metric descriptive of a comparison between said trial analysis result and said training analysis result;
calculating a fairness score metric by comparing said one or more chosen variables to said trial analysis result;
calculating a combined metric from said fairness score metric and said accuracy metric; and
modifying the adjustable parameters of the artificial intelligence model using a training algorithm that receives at least said combined metric as input.

2. The method of claim 1, wherein said method further comprises providing a fairness weighted ranking for each of multiple trained artificial intelligence models by:
receiving said multiple trained artificial intelligence models, wherein said multiple trained artificial intelligence models comprises said artificial intelligence model;
receiving a testing data set for testing said multiple intelligence models, wherein said testing data set comprises multiple groups of testing input data paired with a testing analysis result;
receiving a mitigation analysis result from each of said multiple artificial intelligence models in response to inputting said multiple groups of testing input data as said input data set;
calculating an accuracy score for each of said multiple trained artificial intelligence models descriptive of a comparison between said mitigation analysis result for each of said multiple trained artificial intelligence models and said testing analysis result;
calculating a fairness rating metric for each of said multiple trained artificial intelligence models by comparing said one or more chosen variables to said trial analysis result; and
calculating said fairness weighted ranking for each of said multiple trained artificial intelligence models by combing said fairness rating metric and accuracy score for each of multiple trained artificial intelligence models.

3. The method of claim 2, wherein said fairness rating metric is descriptive of a correlation between one or more chosen values of said one or more chosen variables and said trial analysis result.

4. The method of claim 2, wherein said multiple trained artificial intelligence models are of different types.

5. The method of claim 2, each of said multiple trained artificial intelligence models are independently any one of the following: a neural network, a classifier neural network, a convolutional neural network, a Bayesian neural network, a Bayesian network, a Bayes network, naive Bayes classifiers, belief network, or decision network, a decision trees, a support-vector machine, a regression analysis, and a genetic algorithm.

6. The method of claim 1, wherein said fairness weighted ranking comprises any one of the following: a least squares combination of said fairness rating metric and said accuracy score, weighted lease squares combination of said fairness rating metric and said accuracy score, a linear combination of said fairness rating metric and said accuracy score, a weighted combination of said fairness rating metric and said accuracy score, and a polynomial combination of said fairness rating metric and said accuracy score.

7. The method of claim 2, wherein said combined metric is said accuracy score multiplied by a scaling factor raised to a predetermined power, wherein said scaling factor is a function of said fairness rating metric.

8. The method of claim 7, wherein said scaling factor is a reciprocal of said fairness rating metric.

9. The method of claim 1, wherein said fairness score metric is descriptive of a correlation between one or more chosen values of said one or more chosen variables and said trial analysis result.

10. The method of claim 1, wherein said combined metric comprises any one of the following: a least squares combination of said fairness score metric and said test metric, weighted lease squares combination of said fairness score metric and said test metric, a linear combination of said fairness score metric and said test metric, a weighted combination of said fairness score metric and said test metric, and a polynomial combination of said fairness score metric and said test metric.

11. The method of claim 9, wherein said combined metric comprises any one of the following: a constraint on said fairness score metric, a constraint on said test metric, a maximum allowed value for said fairness score metric, and a maximum allowed value for said test metric.

12. The method of claim 1, wherein said artificial intelligence model is any one of the following: a neural network, a classifier neural network, a convolutional neural network, a Bayesian neural network, a Bayesian network, a Bayes network, naive Bayes classifiers, belief network, or decision network, a decision trees, a support-vector machine, a regression analysis, and a genetic algorithm.

13. The method of any one of claim 1, wherein said artificial intelligence model is a convolutional neural network, and wherein said training algorithm is a deep learning algorithm.

14. A computer program product comprising a computer-readable storage medium having computer-readable program code embodied therewith, said computer-readable program code configured to implement the method of claim 1.

15. A computer system comprising:
a processor configured for controlling the computer system; and
a memory storing machine executable instructions, wherein execution of said instructions causes said processor to:
receive a training data set for training an artificial intelligence model, wherein the artificial intelligence model has adjustable parameters, wherein said artificial intelligence model is trained to providing an analysis result in response to receiving an input data set, wherein said input data set comprises one or more chosen variables wherein said training data set comprises multiple groups of training input data paired with a training analysis result;
receive a trial analysis result from said artificial intelligence model in response to inputting said multiple groups of training input data as said input data set into said artificial intelligence model;
calculate an accuracy metric descriptive of a comparison between said trial analysis result and said training analysis result;
calculate a fairness score metric calculated by comparing said one or more chosen variables to said trial analysis result;
calculate a combined metric from said fairness score metric and said accuracy metric; and
modifying the adjustable parameters of the artificial intelligence model using a training algorithm that receives at least said combined metric as input.

16. The computer system of claim 15, wherein execution of the instructions further causes said processor to:
receive said multiple trained artificial intelligence models, wherein said multiple trained artificial intelligence models comprises said artificial intelligence model;
receive a testing data set for testing said multiple intelligence models, wherein said testing data set comprises multiple groups of testing input data paired with a testing analysis result;
receive a mitigation analysis result from each of said multiple artificial intelligence models in response to inputting said multiple groups of testing input data as said input data set;
calculate an accuracy score for each of said multiple trained artificial intelligence models descriptive of a comparison between said mitigation analysis result for each of said multiple trained artificial intelligence models and said testing analysis result;
calculate a fairness rating metric for each of said multiple trained artificial intelligence models by comparing said one or more chosen variables to said trial analysis result; and
calculate said fairness weighted ranking for each of said multiple trained artificial intelligence models by combing said fairness rating metric and accuracy score for each of multiple trained artificial intelligence models.

17. The computer system of claim 15, wherein the artificial intelligence model is any one of the following: a neural network, a classifier neural network, a convolutional neural network, a Bayesian neural network, a Bayesian network, a Bayes network, naive Bayes classifiers, belief network, or decision network, a decision trees, a support-vector machine, a regression analysis, and a genetic algorithm.

18. The computer system of claim 15, wherein said artificial intelligence model is a convolutional neural network, and wherein said training algorithm is a deep learning algorithm.

19. A computer program product, said computer program product comprising a computer readable storage medium having stored thereon an artificial intelligence model trained according to the method of claim 1.

20. A memory for storing data for access by an application program being executed on a data processing system, comprising: an artificial intelligence model trained according to the method of claim 1.
